(19) United States
(12) Patent Application Publication
(10) Pub. No.: US 2025/0067242 A1
(43) Pub. Date: Feb. 27, 2025

(54) Rotor Structure for Fluid Kinetic Power Generation Turbine

(71) Applicant: Che-Chih Tsao, Hsinchu (TW)

(72) Inventor: Che-Chih Tsao, Hsinchu (TW)

(21) Appl. No.: 18/238,491

(22) Filed: Aug. 27, 2023

(51) Int. Cl. F03D 1/06

(52) U.S. Cl. CPC F03D 1/0658; F05B 2260/30

(57) ABSTRACT

This invention describes a new structural design for rotors used in fluid kinetic power generation with the aims of reducing rotor mass while maintaining rotor strength or increasing strength without increasing material costs significantly. The basic concept is to use a set of guy wires attached to rotor blades so that each blade is supported at multiple positions along the blade span. Between two adjacent support positions, the length of unsupported overhanging blade section is reduced as compared to the whole blade length. Fluid dynamic loading induced bending and shearing along the blade can thus be reduced significantly.

### CROSS REFERENCE TO RELATED APPLICATIONS

This application claims the benefit of provisional patent application Ser. No. 63/401,609, filed on Aug. 27, 2022, by the present inventors, which is incorporated by reference in its entirety.

### BACKGROUND OF THE INVENTION

### 1. Field of the Invention

The present invention relates to packaging structures and methods of electronic devices, especially of capacitor devices.

### 2. Background

A rotor is at the heart of a fluid kinetic power generation system, such as a wind turbine or a tidal current turbine. The rotor converts the kinetic power of generally linear fluid flow into rotational motion so that an electric generator can be applied to extract the energy flow. In a modern commercial grade wind turbine, the rotor (including blades and a hub) is an expensive assembly. On the average, a rotor costs about 15-25% of a whole wind turbine, which has a unit capacity cost of about 1 million US dollar per 1 MW for land-based systems (per Gasch, R. and Twele, J., Wind Power Plants: Fundamentals, Design, Construction, and Operation, 2nd ed., Berlin: Springer-Verlag, 2012, Chap. 15). For example, a wind turbine rated at 3.0 MW can have three blades, with each blade of 47 m in length, 12,500 kg in. weight and costing USD$250,000 to 300,000 (per Red, C., “Wind turbine blades: Big and getting bigger”, CompositeWorld, June 2008, Gardner Business Media, Inc., from www.compositesworld.com/articles/wind-turbine-blades-big-and-getting-bigger). In order to become more competitive with respect to fossil fuel and nuclear power generations, reducing rotor cost can have a significant effect.

By the fundamental Betz law, the larger the rotor, the more energy flow it can capture. The weight associated with large rotors presents various challenges in design, engineering and manufacturing, as well as associated cost penalties. For examples, FIG. 1 plots power capturing and torque input for different rotor diameters together with typical weights of subsystems of commercial wind turbines. One can see that rotor takes a very significant portion of the total weight of a wind turbine. For example, as indicated in the chart, in a wind turbine of 80 m diameter rotor, the weight of the rotor can be over 50 tons, with the 3 blades, the hub and the pitching mechanism taking over ⅔ of the total assembly weight, well over the weights of the corresponding gearbox and the generator.

The weight and size of the rotor make transportation and assembly more difficult. Special trailers and traffic controls are necessary for transporting long and heavy blades over land. Long distance transportation is either impractical or becomes a very significant cost factor. Heavy duty tall cranes are required for assembling the blades and the hub onto the nacelle. This is especially costly for installation of offshore wind power systems, which requires special crane vessel and transportation barges (per Kaiser and Kaiser, M. J. and Snyder, B. F., Offshore Wind Energy Cost Modeling, London: Springer-Verlag, 2012).

The size and weight of large rotors also impose additional strength requirements in order to avoid undesirable dynamics and fatigue. By the scaling rule, when a blade size (area) is increased, in order to maintain the stress due to fluid dynamic forces at a constant level, the cross-sectional area of the blade must also increase in proportion. This leads to a blade weight proportional to the cube of its length. (per Gasch and Twele, ibid., Chap. 7). Such a blade in large size can exert on itself a cyclic stress, proportional to the blade length, as it rotates, and manufacturing and material requirements become very costly (see, for example, Gurit, Wind Energy Handbbok, Chap. 2 Wind Turbine Blade Structural Engineering, Gurit Holding AG, Wattwil/Switzerland, from http://www.gurit.com/wind-energy -handbook-1.aspx). Lightweight designs with increased fiber reinforcement have been able to keep blade weight proportional to roughly the square (or exponent 1.9˜2.2) of the blade length, instead of cube, on large commercial wind turbines (per Gasch and Twele, ibid., Chap. 3 and Leithead W. E., “Wind Trubine Scaling and Control”, presentation slides, Supergen Wind, EPSRC, UK, 2011, from www.supergen-wind.org.uk/docs/presentations/2011-03-24_Session5_BillLeithead.pdf). This practically makes the blade weight proportional to its surface area rather than its apparent volume and breaks the weight scaling rule. However, costs of additional fibers do increase. As a result, specific costs ($ per kW capacity) of commercial wind turbines do not appear to decrease significantly with increasing capacity (per Gasch and Twele, ibid., Chap. 15).

Large and longer blades also need higher stiffness so that the blade tips do not bend too much under strong wind and the safety clearance between the blade tip and the tower body can be satisfied. Higher stiffness is also needed to keep the natural frequency of vibration above the tower passing frequency in order to avoid resonance, and hence avoiding fatigue. This is because long and heavy blades tend to have lower natural frequency of vibration, which can become close to the frequency of the blades' passing the tower, which also becomes lower for larger rotors. All these factors result in the need for more materials and stronger material, such as carbon fiber, which costs 7-8 times higher than glass. The need for more materials also poses manufacturing difficulties, such as high exothermic temperatures affecting the quality of laminate when making thick blade roots, which implies strict process and quality control, thus additional manufacturing costs, are necessary. (for example, see Gurit, ibid., Chap. 3).

Heavy and large rotors also need strong bearings, shafts, nacelle chassis and towers, which add' more weight and could lead to adverse results to the system. For example, the large size and weight of the rotor, of existing designs, coupled with stochastic wind conditions, can lead to extra loads and accelerated wear in the drive train. A study initiated in 2007 by the U.S. National Renewable Energy Laboratory, in response to several gearbox failure incidences, concluded that most wind turbine gearboxes in the field will fail “well before” their 20-year design life (per Fairley P., “Wind Turbines Shed Their Gears”, MIT Technology Review, Apr. 27, 2010, from www.technologyreview.com/news/418689/wind-turbines-shed-their-gears/). As a result, one of the common maintenance requirements is to replace the gearbox every five years, which is a costly task since it accounts for about 10% of the total wind turbine construction and installation cost. Studies traced probable cause of gearbox failure to uneven loading on the rotor blades under random gusting of the wind. Such an uneven loading generates a torque on the rotor shaft that will unevenly load the bearing and misalign the gear teeth, which results in uneven wear of the teeth, which promotes further misalignment and uneven wear. (per Ragheb, A. M. and Ragheb, M., “Wind Turbine Gearbox Technologies”, in Chap. 8 of Fundamental and Advanced Topics in Wind Power, ed. by Carriveau, R., published by InTech, Jul. 15, 2011, from cdn.intechopen.com/pdfs-wm/16248.pdf) Although this random gusting effect relates directly to rotor size (area), rather than weight, the weight effect comes into play in the form of loading shaft bearings and deforming nacelle chassis, causing misalignment of components in the drive train, which will further accelerate uneven wear once it begins.

In existing wind turbines, flexible blade-hub connection design has been applied to ease unbalanced wind pressure (thrust) due to non-uniform and stochastic wind field. For small to medium size wind turbines, flapping hinge design uses a flapwise hinge to connect each blade with the hub. The flapping angle is self-adjusting by a balance between wind thrust and centrifugal force on each blade. As a result, bending in the blades and roots is greatly reduced and blade weight can be reduced up to 75%. However, returning springs or other supporting mechanisms are required to maintain the flapping angle at low rotational speeds, such as in startup and slowing down, when the centrifugal force is not big enough. For large rotors, teetering hub design, which uses a single hinge on two connected blades, has been applied. This design eases dynamic unbalance but not the static bending load on the blades. Further, rotors using these designs need to be placed downwind, so that flapping or teetering does not make the blade tips too close to the tower. (Gasch and Twele, ibid., Chap. 3) Therefore, these designs are all affected by the effect of tower wake.

There are several recent developments of new blade design concept. It was reported that GE Global Research was developing a new blade design aimed at cutting blade cost by 25 to 40%. The new design includes a skeleton of metal ribs and new fiberglass-based fabrics to be wrapped around the skeleton as skin. (See “Can You Knit a Wind Turbine?” GE Wind Turbine Blades Made From Fabric Aim To Revolutionize Renewable Energy”, GE Reports, Dec. 3, 2012, General Electric Company, from www.gereports.com/post/74545105851/can-you-knit-a-wind-turbine-ge-wind-turbine-blades, which is incorporated by reference herein for the current patent application.) Wetzel reported a project funded by the USDOE to develop a “Modular Space Frame Blade” featuring separate sections, each having 3 solid spars connected by ribs and covered with fabric as non-structural shell without cores. The sections are to be factory assembled, sized for transportation and assembled in the field. (See Wetzel, K. K., “Modular Blade Design and Manufacturing”, presentation slides, Wetzel Engineering Inc., Austin, Texas, USA, 2014, from www.slideshare.net/sandiaecis/2014-wind-turbine-blade-workshop-wetzel, which is incorporated by reference herein for the current patent application.) Rudling described a modular spar design featuring multiple spars that can be connected by overlapping shear webs for ease of assembly. (See Rudling, P., “Wind Turbine Blade”, U.S. Pat. No. 8,696,317, 2014, which is incorporated herein by reference for the current patent application.) Jensen described a lightweight approach of reinforcing blade shell by applying tension wires to connect strategic spots on the inside surfaces of the two half shells, mainly for preventing shell deformation or buckling. (See Jensen, F. M., “Reinforced Wind Turbine Blade”, U.S. Pat. No. 8,807,953, 2014, which is incorporated by reference herein for the current patent application.) Thus, these new developments represent a direction of modularization to reduce manufacturing and transportation costs.

The situation is quite similar in power generation from marine currents. Because sea water has a density over 800 times of air, for a marine turbine rotor of the same size, the thrust over the rotor can be much larger than in the case of wind turbine, even if the current flow speed is much smaller than wind speed. A marine current turbine can also be supported by a tower fixed to seafloor, such as the case of Atlantic Resources AR1500 (see MeyGen Ltd., “Meygen The Tide of Change in Caithness: MeyGen Phase 1 EIA Scoping Document”, 24 May 2011). A marine turbine can also be mounted to a support structure on a floating, or submerged floating, fuselage that is moored by lines and anchors, such as the case of Orbital Marine O2 (See Orbital Marine, company website, orbitalmarine.com/o2/).

### BRIEF SUMMARY OF THE INVENTION

Accordingly, it would be very preferable if the weight of turbine rotor can be reduced while the strength is maintained. This invention describes a new design for rotors with the aims of reducing rotor mass while maintaining rotor strength or increasing strength without increasing material costs significantly.

The loading on a wind turbine rotor comes from three major sources: weight, centrifugal force and fluid dynamic force. According the scaling rules, stress due to centrifugal force is not a function of rotor size. Therefore, rotor weight exists mainly for resisting loading from fluid dynamic forces. An examination of the fluid dynamic forces acting on a rotor of current design reveals that loadings are highly dependent on directions. FIG. 2 compares the effects of fluid dynamic forces on a blade in two perpendicular directions: flap-wise and edgewise. Shown in the figure are the thrust coefficient C_{T}(λ) and the moment coefficient C_{M}(λ) of a wind turbine with a designed tip speed ratio λ_{D} of 7 with respect to different tip speed ratios λ and different pitch angles γ, calculated by Betz-Schmitz geometry using the blade element momentum method. The thrust coefficient is defined as

$$Thrust T = {C}_{T} ( λ ) ( ρ / 2 ) π {R}^{2} {{v}_{1}}^{2} ;$$

while the moment coefficient is defined as

$$Momennt M = {C}_{M} ( λ ) ( ρ / 2 ) π {R}^{3} {{v}_{1}}^{2}$$

wherein ρ is air density, R is rotor radius, and v₁ is wind speed. Take note that the ratio of the two coefficients,

$${C}_{T} ( λ ) / {C}_{M} ( λ ) = TR / M ,$$

represents a measure of thrust induced bending moment flapwise vesus torque moment in the edgewise direction. FIG. 2 clearly indicates that aerodynamics induced flap-wise bending moment is far larger than edgewise bending moment for a wide range of pitch angles. At the designed tip speed ratio λ_{D}=7 with no pitch, C_{T} is almost an order of magnitude larger than C_{M}. (FIG. 2 is a summary of data taken from FIG. 6-3, FIG. 6-4, FIG. 6-16 and FIG. 6-17 of Chapter 6 of Gasch and Twele, ibid.)

The above observation provides the inspiration of this invention in finding more effective ways to take the flap-wise loading in order to achieve a lighter and more cost effective rotor design. Since flapwise bending is the dominant loading on the rotor, relieving such bending will reduce the amount of materials required on the blades and the hub and thereby reduce weight and cost. In structural design, the most effective way to resist a load is to take it by direct tension or compression, rather than by bending. Accordingly, the basic concept of this invention follows this principle of structure design. FIG. 3 illustrates the basic idea of the current invention. The rotor structure 100 includes rotor blades 120, hub 110 and a set of guy wires 200. The guy wires are attached to rotor blades to take the thrust forces directly by the tension of the guy wires. Each of the guy wires has its one end attached to a corresponding brace location on a corresponding rotor blade such that, a rotor blade is supported by multiple guy wires at multiple brace locations 220 along the radial span of the blade. Along each guy wire in the direction opposite to its brace location on a blade, the guy wire is restrained at a restraining position on a restraining structure 230 located upstream of and on the axis of the rotor such that most or all of the thrust force on the rotor blades is transferred by the guy wires to the restraining structure and the sum of the forces exerted on the restraining structure points along the axis of and at the rotor. In other words, the thrust forces acting on the radially extended rotor blades are now transferred into the tensions of the guy wires and concentrated and redirected along the axis of the rotor. The blades are no longer under cantilever bending. Between two adjacent brace locations, the length of unsupported overhanging blade section is reduced as compared to the whole blade length. Fluid dynamic loading induced bending and shearing along the blade can thus be reduced significantly. With reduced loading, less material will be needed in the blades and the hub and rotor weight can be reduced. By reducing the weight of both the blades and the hub, the weight of corresponding bearings and pitching mechanisms can also be reduced. As a result, the ratio of strength to mass of the rotor can be increased.

The concentrated forces on the restraining structure acting along the rotor axis can be balanced/supported by two different approaches. The first approach is to apply a compression structure 240 between the restraining structure and the rotor hub and transfer the concentrated forces on to the rotor hub. The rotor hub, with its shaft, bearing and related structure in the nacelle 40 of the turbine are in turn supported and held by a tower 30 or other structures, in the cases of marine current power turbine. The second approach is to hold the restraining structure from the upstream direction by a tension structure 400, which is to be supported from the upstream. This approach is mainly suitable for marine current power, because the rotor structure can be made to have an averaged density close to sea water so that it can float under water when supported from the upstream end. In this approach, it is preferred to place the nacelle 40 in front of the tension structure 400. The tension structure will also drive the gearbox and the generator in the nacelle when the rotor structure rotates. The nacelle is fixed to an anchor by a mooring line (or a set of lines) or to a tower fixed to seafloor.

### BRIEF DESCRIPTION OF THE DRAWINGS

FIG. 1 shows power capturing and torque input for different rotor diameters together with typical weights of subsystems of commercial wind turbines.

FIG. 2 shows comparison of the effects of fluid dynamic forces on a blade in two perpendicular directions: flap-wise (thrust coefficient) and edgewise (moment coefficient).

FIG. 3 depicts the basic concept of the current invention.

FIG. 4A and FIG. 4B depict the first preferred embodiment of the current invention using a two-blade rotor as example, featuring a compression structure to take concentrated forces from guy wires.

FIG. 5 depicts the second preferred embodiment of the current invention using a two-blade rotor with blade flapping mechanisms as example, similar to that of FIG. 4 but featuring a sheave mechanism on the restraining structure for accommodating unbalanced load on blades.

FIG. 6A, FIG. 6B and FIG. 6C depict the function of the sheave mechanism in the embodiment of FIG. 5, according to the current invention.

FIG. 7 depicts the third preferred embodiment of the current invention using a three-blade rotor as example, similar to that of FIG. 5 but featuring a different sheave mechanism for the three-blade situation.

FIG. 8 depicts the arrangement of the guy wires and the sheave system for accommodating unbalanced load on blades for a 3-blade rotor according to the current invention.

FIG. 9A, FIG. 9B and FIG. 9C depict example details of the connection between a guy wire and a brace location on a blade according to the current invention.

FIG. 10A, FIG. 10B and FIG. 10C depict covering over guy wires and bridle lines to reduce flow drag.

FIG. 11A and FIG. 11B illustrate the fourth preferred embodiment of the current invention, featuring a tension structure to take concentrated forces from the guy wires.

FIG. 12A, FIG. 12B and FIG. 12C depict the fifth preferred embodiment of the current invention, featuring a compound tension structure that not only takes concentrated forces from the guy wires but also drives the generator, using a 2-blade rotor as example.

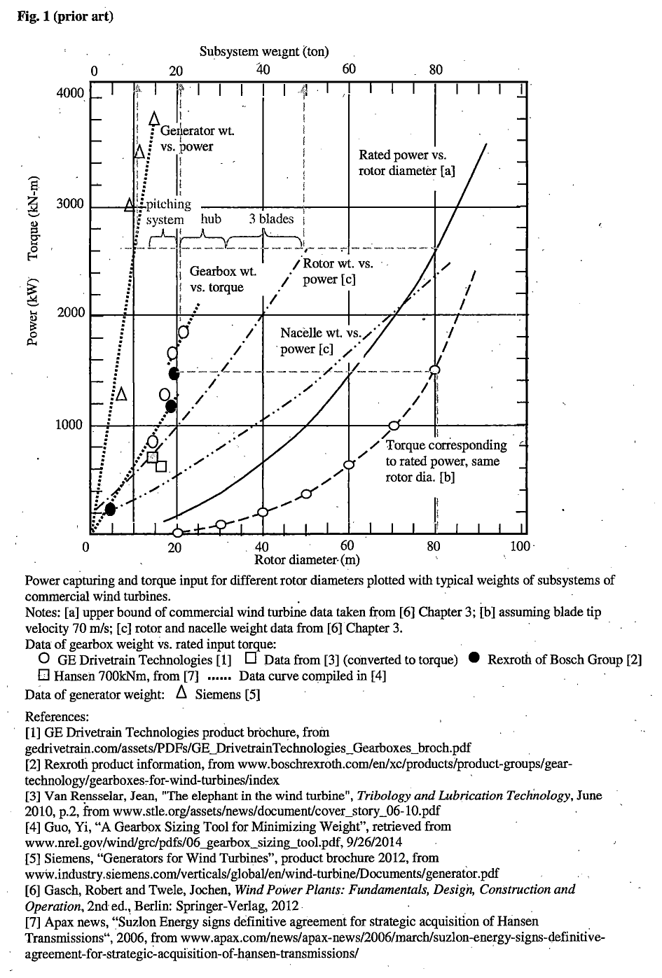

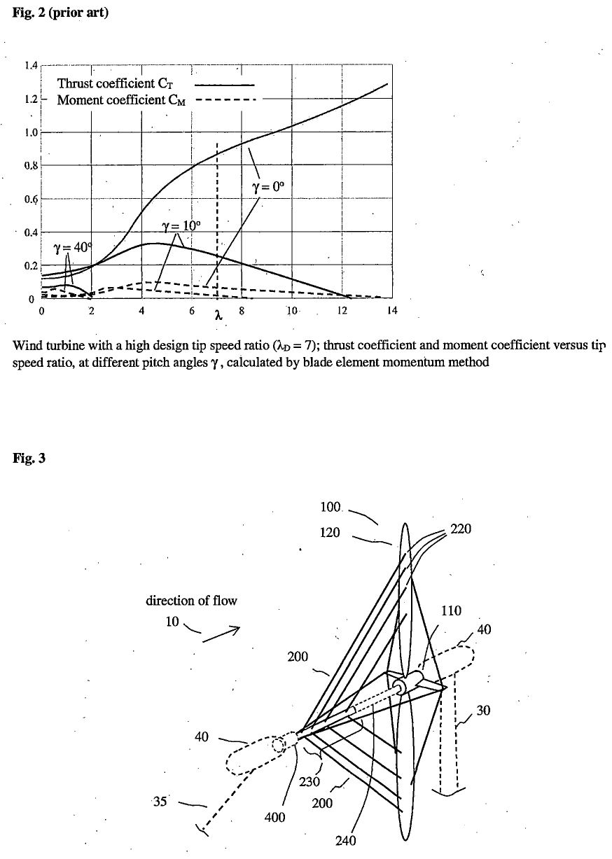

### DETAILED DESCRIPTION

The invention can be better understood through the detailed descriptions of examples of embodiments below.

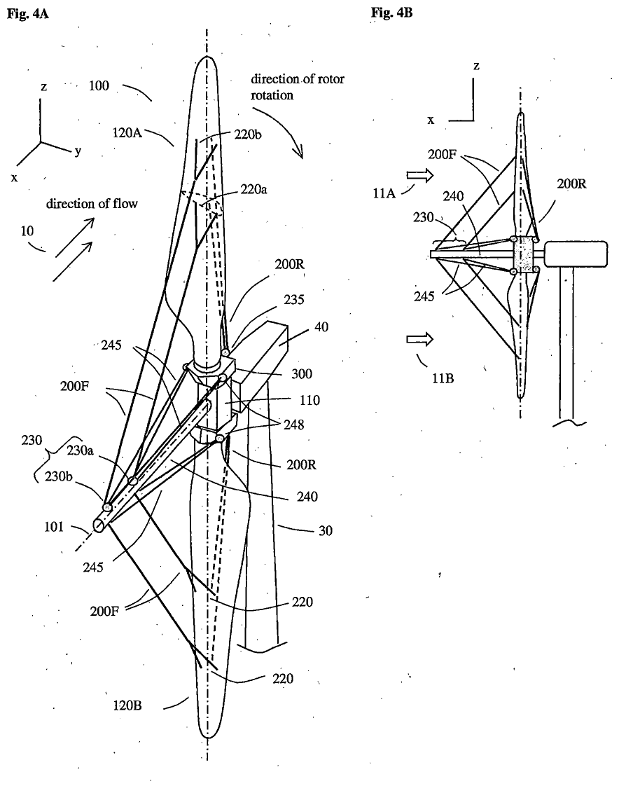

FIG. 4 illustrates the first preferred embodiment of the current invention using a two-blade rotor as example, featuring a compression structure to take concentrated forces from guy wires and a tower support. FIG. 4A shows a perspective view and FIG. 4B shows a side view. The rotor 100, including two blades (120A, 120B) and the hub 110, is positioned in front of the nacelle. 40, which is supported above a tower 30, facing the incoming fluid flow 10. Each blade (120A, 120B) is supported by guy wires, including front guys 200F and rear guys 200R. The front guys 200F act as thrust braces bracing the blades at multiple brace locations 220 along the blade span. The opposite ends of the front guy wires are brought close to the axis of the rotor 101 and restrained to guy restraining positions (230a, 230b) on a restraining structure 230. A compression structure, specifically a central post 240, supports the restraining structure 230 and connects to the hub 110. Therefore, through the central post along the rotor axis 101, the set of guy wires transfer and redirect most of the loading exerted on the rotor blades to the rotor hub through wire tension and structural compression, rather than cantilever bending. Between two adjacent brace locations, for example 220a and 220b, or from the hub 110 to the first brace location 220a, the length of. unsupported overhanging blade section is reduced as compared to the whole blade length. Fluid dynamic loading induced bending and shearing along the blade can thus be reduced significantly. Forces on the hub can also be reduced. With reduced loading, less material will be needed in the blades and the hub and rotor weight can be reduced. By reducing the weight of both the blades and the hub, the weight of corresponding bearings and pitching mechanisms can also be reduced. As a result, the ratio of strength to mass of the rotor can be increased. In order to reduce weight and for easy assembly, the central post is positioned and mounted not only by using the front guys 200F but also by additional post side guys 245, like a mast supported by stays and shrouds on a sail ship. In addition, the rear guys 200R brace the blade at the rear side, protecting the lightweight blades from being damaged by any possible sudden gust blowing from the rear. The rear guys and the post side guys are tied to tie-up points 235 and 248 respectively on the hub structure.

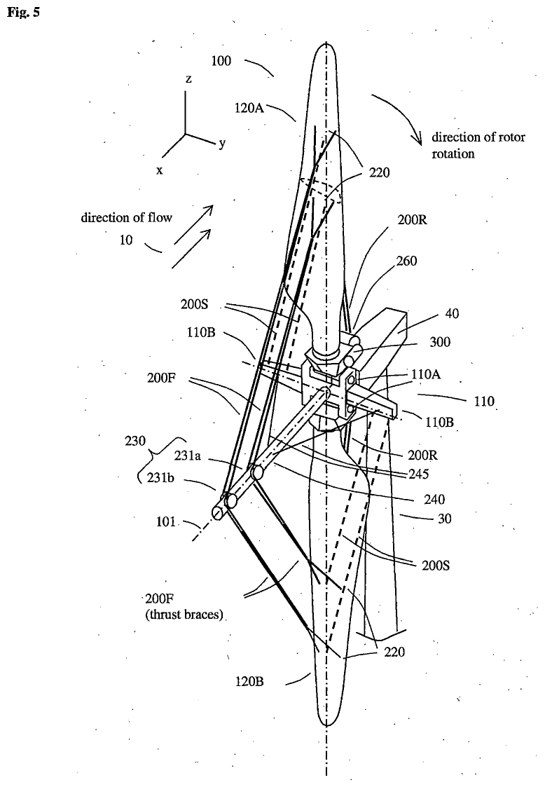

The blade-hub connection can be fixed or flexible. The example illustrated in FIG. 4A uses fixed blade-hub connection. For flexible blade-hub connection, it can be flapping-hinge design or teetering hub design. The example illustrated in FIG. 5 uses independent flapping hinges. FIG. 5 depicts the second preferred embodiment of the current invention using a two-blade rotor with blade flapping mechanisms as example. The hub 110 now includes a flapping hinge 110A for each blade. The blade can therefore slightly rotate about the hinge in the flapping direction (i.e. the direction of flow). The guy wire system is similar to that of FIG. 4A but featuring a sheave mechanism on the restraining structure 230 for accommodating unbalanced load on blades. A set of front guy wires 200F and a set of rear guys 200R in proper tension keep the blades erected in position. A tension spool mechanism 260 on the hub holding the rear guys provide the required tension. With the central post in position, the rotor is positioned in front of the tower to the upstream direction. Therefore, unlike traditional flapping-hinge design, there will be no tower wake effect on the rotor.

It is known that due to non-uniform wind speed distribution at different elevation from the ground or due to random gusting loading on each blade of the rotor may be different. This will result in bending moments in directions perpendicular to the rotor axis, which can cause excess fatigue to the rotor shaft as well as the transmission gears. In FIG. 4A, each front guy is a separate and individual wire that connects to one blade at one end and to the restraining structure at the other end at a guy restraining position. If the guy is fixed to the restraining position as a fixed attachment, the bending moment due to uneven wind loading on the blades can still happen. Therefore, it is preferred that the front guys connecting the blades are supported on the restraining structure through a mechanism that transfers minimal lateral forces to the restraining structure and the central post. This way, uneven loading on the blades will not bend the central post and thrust loading can always be transferred along the longitudinal direction of the central post. A group of sheaves with a change of arrangement of front guys can achieve this purpose. As illustrated in FIG. 5, each front guy 200F will now connect to the two blades and each guy wire will be supported on the restraining structure 230 by partially wrapping around a rotatable sheave (231a, 231b). This way, the tension on the guy wire will remain the same even if the two blades are under uneven loads. The sheave system will average out the tension and the tension spool mechanisms 260 will react and make up the difference in the loads. Therefore, only axial force parallel to the rotor axis 101, no lateral forces, will be exerted on the central post. Further, for one restraining position, e.g. at 231a, one guy wire around one sheave are used at each of the two sides of the restraining structure 230, as shown in FIG. 5, so that forces are also balanced on the two lateral sides of the central post.

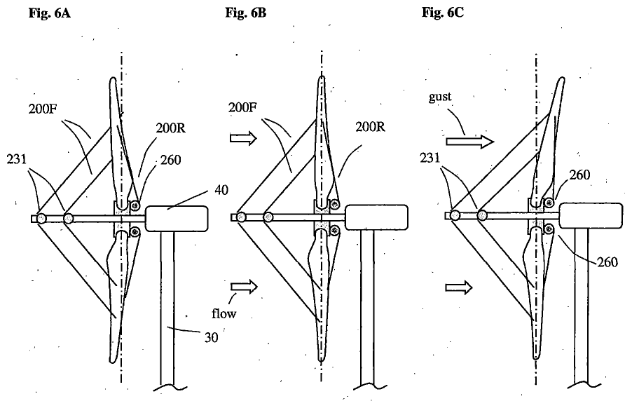

Because the blades in FIG. 5 applies independent flapping hinges 110A, when one of the two blades is experiencing an excessive load, the overloaded blade will flip slightly downwind and lose some angle of attack, and thus unload some excessive loading, until the wind condition comes back to normal. This is depicted in FIG. 6A, FIG. 6B and FIG. 6C. FIG. 6A shows that when there is no wind, the pre-tension in the front guys and the tension spools 260 on the hub will keep a cone angle on the blades. That is, the blades slightly lean toward the front. When in normal operation, the cone angle become roughly 180 degree. That is, the two blades appear aligned as a straight line when viewed side, FIG. 6B. When there is a local gust, one blade could lean slightly downstream, while the front guy wires can move along because of the rotatable sheaves 231, as shown in FIG. 6C.

The front guys 200F help reducing bending loads on blades in the flap-wise direction. To further. reduce the bending loads in the edgewise direction (i.e. rotor rotating direction) on the blades, side posts 110B, fixed to the hub, and side guys 200S can be added, as shown in FIG. 5. The side guys 200S are placed behind the trailing edges of the blade and tied to the brace locations 220 on the blades and to the side posts 110B. Basically, fluid dynamic forces on the blades in the edgewise direction are transferred into tensions on the side guys, which then pull on the side posts and rotate the rotor. Edgewise bending moments on the blades near the bases and the hub are therefore reduced.

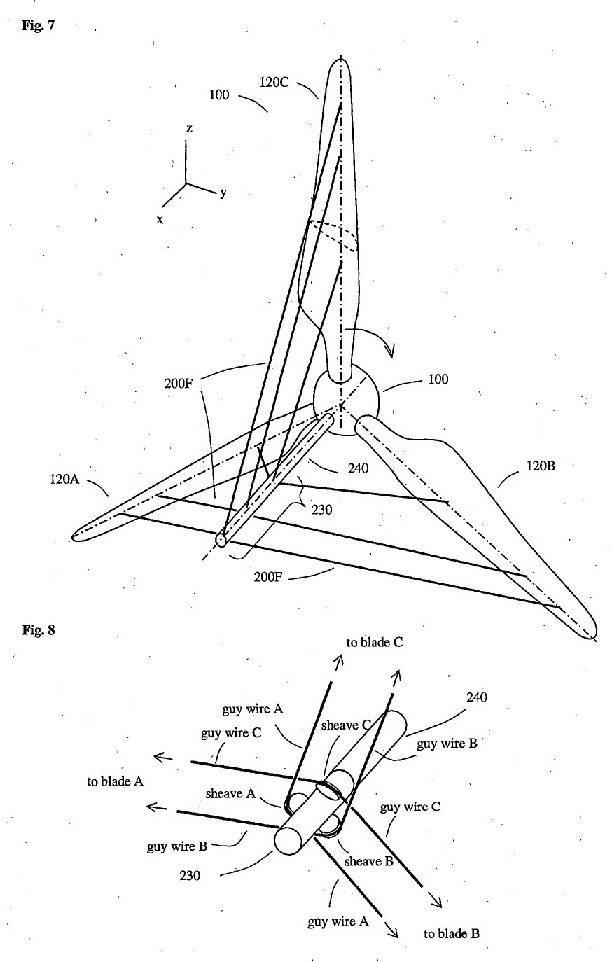

FIG. 7 shows a 3-blade rotor with front guys. The situation is basically similar to the arrangement of FIG. 4A except with 3 blades.

To apply the sheave-based restraining structure similar to that of FIG. 5 to a 3-blade rotor requires some modification in guys-sheave arrangement. FIG. 8 shows one set of sheaves and guy wires for holding each blade at one location for a 3-blade rotor that can achieve the same function as the example of FIG. 5. The set includes 3 sheaves and 3 guy wires. Each blade is held at one brace location by 2 guy wires; and the 2 guy wires pass around 2 sheaves respectively and lead to 2 other blades respectively. For example, both guy wires B and C are connected to one location on blade A at one end. Guy wire B wraps partially around sheave B and then reaches blade C, while guy wire C wraps partially around sheave C and then reaches blade C and then reach blade B.

Blades need pitch control systems so that the turbine rotor can adapt to varying wind/flow conditions. In FIG. 4A, the base of the pitch systems (including mechanism and actuators) 300 is attached to the hub 110 directly. In FIG. 5, the base of the pitch system 300 is attached to the flipping parts of flapping hinges 110A.

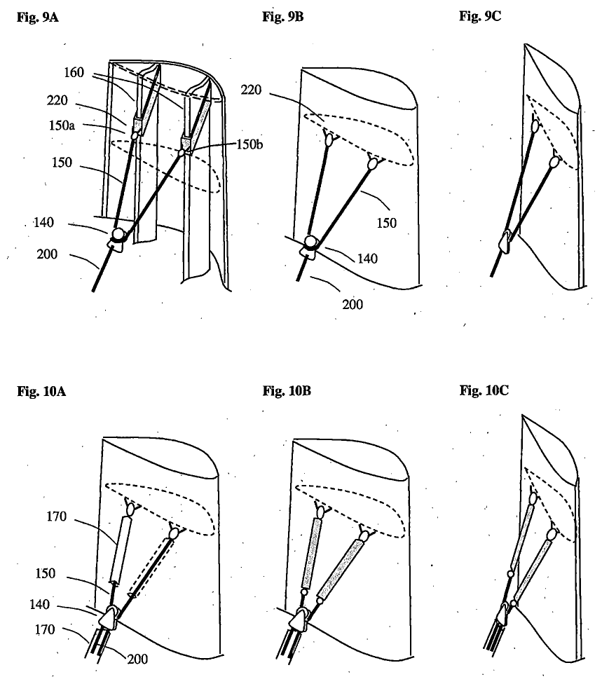

A guy wire (or a pair of guy wires in the case of FIG. 5 and FIG. 8) connects to one brace location on the blade through a bridle line, similar to the bridle line of a kite. As shown in FIG. 9B, the guy 200 connects to the bridle line 150 through a pulley 140 to form a movable towing point. When the pitch angle of the blade changes, the towing point can move accordingly. FIG. 9A shows how the two connecting points 150a and 150b of the bridle line on the blade should be attached to the internal structure, generally, the spar 160, of the blade.

To reduce fluid dynamic drag, a significant portion of the guy wires and the bridle lines can be covered with tubular covering of streamlined cross section 170. The covering can be made from thin polymer sheets. FIG. 10A, FIG. 10B and FIG. 10C depict the idea.

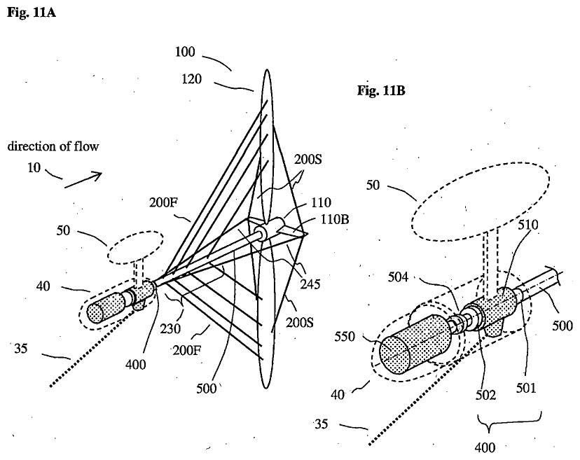

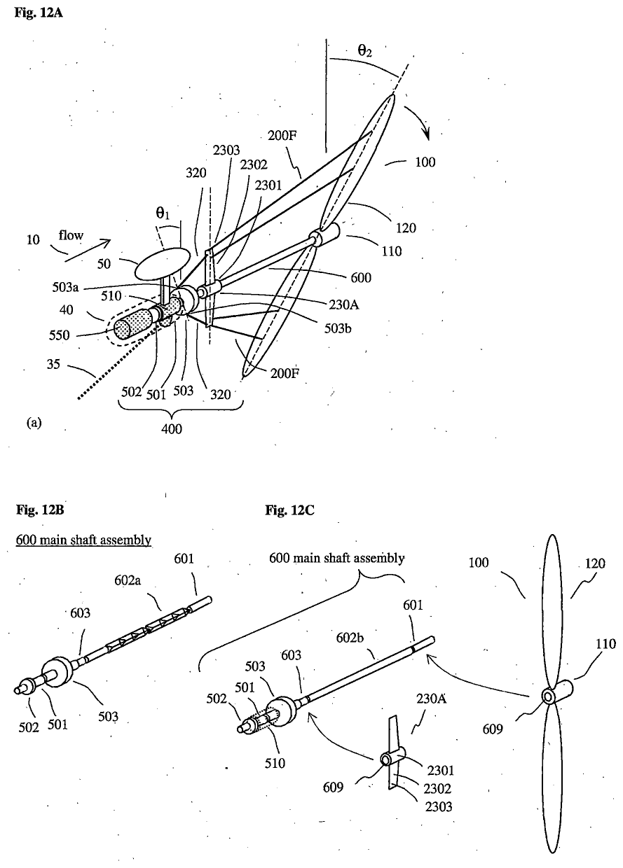

FIG. 11A and FIG. 11B illustrate the fourth preferred embodiment of the current invention, featuring a tension structure to take concentrated forces from the guy wires. The rotor structure is similar to that of FIG. 4A, including a hub 110, blades 120, front guy wires 200F and a central post 500. The front guy wires are restrained to a restraining structure 230 in the front section of the central post. It also includes side post 110B and side guy wires 200S, similar to those of FIG. 5. The front end of the restraining structure 230 is rigidly connected to a drive shaft 501 with a flange-like shaft head 502. A drive shaft housing 510 holds the drive shaft at the drive shaft head 502 with a set of thrust bearings and the shaft body 501 with journal bearings. The drive shaft housing 510 is then supported by a mooring line 35 with an anchor (not shown) or by other fixed structure. As a result, the thrusts over the rotor blades are transferred through the guy wires 200F to the restraining structure 230 and then to the drive shaft and then exerted onto the draft shaft housing 510 via the shaft head 502. That is, the draft shaft and the shaft head act as a tension structure 400 to hold the thrusts of the rotor. The front end of the drive shaft is further connected, via a shaft coupler (or a transmission mechanism) 504 to the generator 550. The generator 550 and the drive shaft housing 510 are both fixed to the nacelle 40. The drive shaft head 502, the drive shaft 501, the restraining structure 230 and the central post 500 and the hub 110 are all connected as an integral body. The rotation of the rotor rotates this whole integral body. As a result, this whole integral body acts as a torsion bar to drive the generator. When the system is used in marine current power generation and is moored by anchor lines, a buoy structure 50 at the top of the nacelle 40 helps to balance the weight of the system and to provide a countering moment to the torque resulted from driving the generator.

FIG. 12A, FIG. 12B and FIG. 12C illustrate the fifth preferred embodiment of the current invention, featuring a compound tension structure that not only takes concentrated forces from the guy wires but also drives the generator, using a 2-blade rotor as example. The rotor structure is similar to that of FIG. 11A, including a hub 110, blades 120, front guy wires 200F and a main shaft 600. However, the embodiment differs from the one of FIG. 11A in several aspects.

First, the hub rotor 110 is not fixed to the main shaft 600 but is rotatable over it through the use of bearing 609 on a downstream section of the main shaft, called rotor shaft 601 for convenience.

Second, the restraining structure has a construction different from the ones described previously. The restraining structure 230A includes posts 2302 extended outward from a hub 2301. The hub 2301 of the restraining structure is also rotatable over on a section of the main shaft, called restraining structure shaft 603 for convenience, through the use of bearing 609. The front guy wires 200F are attached to the outward ends of the posts at 2303.

Further, an additional set of drive guys 320 connects the post ends 2303 to corresponding locations (503a, 503b) on the outer rim of a drive hub 503 on the main shaft 600. The drive hub 503 is an integral part of the main shaft 600. FIG. 12B and FIG. 12C illustrate two example construction of the main shaft 600. From the downstream end, there is the rotor shaft section 601, which is a shaft for the bearing 609 to ride on, as described earlier. Then there is the center beam section, which can be of a truss structure 602a or of a tube structure 602b, for examples. Next there is the restraining structure shaft 603. The drive hub 503 is connected to the restraining structure shaft 603 and is part of the drive shaft that also includes the drive shaft body 501 and drive shaft head 502, as described earlier. All these sections form an integral main shaft.

The rotor hub 110 rides on the rotor shaft 601. It can rotate freely, under the limitation of the guys. It can also move slightly in the axial direction. The restraining structure 230A rides on the restraining structure shaft 603 in a similar fashion. The drive shaft housing 510 holds the drive shaft body 501 and the shaft head 502 with bearings in a fashion similar to the case of FIG. 11A. So the whole main shaft assembly can rotate relative to the housing 510 and the nacelle 40. In short, there are 3 parts that are rotatable relative to one another, only limited by the guys: the main shaft 600, the restraining structure 230A and the rotor (hub) 110.

When fluid flow pushes the rotor to rotate, the front guys 200F not only brace the blades but also drive the restraining structure 230A to rotate. The restraining structure 230A in turn to pull on the drive hub 503 through the drive guys 320 and also drive it (together with the whole main shaft) to rotate. In the axial direction, the drive shaft/head (510, 502), the drive hub 503 and the drive guys 320 form the tension structure to counter the axial pulling forces on the restraining structure 230A. In the rotational direction, in reference to the situation of no flow, the rotation angle of the rotor leads the restraining structure by an angle θ₂, and the restraining structure leads the drive hub by an angle of θ₁. These angle differences enable the pulling of the front guys 200F and the drive guys 320 in the rotational direction. The freedom of slight axial movements of the rotor (hub) and the restraining structure on their shaft helps to accommodate the system to varying flow speeds, when the angle differences and the spacing among the rotatable parts can change from time to time. The final power output is done by the drive hub that is integrated to the drive shaft that drives the generator. The main advantage of this embodiment, compared to the one of FIG. 11A, is that the main shaft does not need to be a long torsion bar. In this case, torsion exists only from the drive hub 503 to the drive shaft head 501 that is coupled to the generator.

By the application of the guy wires, each blade is supported by the guy wires at multiple positions along the blade span. A blade can then be divided and separated into multiple sections with the division lines at the multiple positions of support along the span. These separate sections can be transported to the field in batches so that the transportation becomes much easier than moving the full blade. They can then be assembled and connected by bolts in the field into a full blade. Without the structure of guys and central post, a modular, sectioned blade will need very strong connection between sections in order to withstand bending. But with the structure of guys and central post, the strength and material requirements on the intersection connections are eased.

### Rotor Structure for Fluid Kinetic Power Generation Turbine

The present invention disclosed herein has been described by means of specific embodiments and process steps. However, numerous modifications, variations and enhancements can be made thereto by those skilled in the art without departing from the spirit and scope of the disclosure set forth in the claims.

1. A light weight high strength rotor structure for fluid kinetic power generation turbine including:
a hub;
a number of blades attached to the hub;
a restraining structure located upstream of the hub and on axis of the hub;
a set of guys wires connected to the restraining structure and bracing each of the blades at multiple brace positions distributed along the span of the blade, the guy wires taking fluid dynamic loads on the blades when the rotor structure rotates;
a compression structure connecting the restraining structure and the hub for resisting reaction forces generated on the guy wires due to the fluid dynamic loads on the blades.

2. A light weight high strength rotor structure for fluid kinetic power generation turbine including:
a hub;
a number of blades attached to the hub;
a restraining structure located upstream of the hub and on axis of the hub;
a set of guys wires connected to the restraining structure and bracing each of the blades at multiple brace positions distributed along the span of the blade, the guy wires taking fluid dynamic loads on the blades when the rotor structure rotates;
a tension structure located to the upstream direction of the restraining structure and connected to the restraining structure for resisting forces generated on the guy wires due to the fluid dynamic loads on the blades, the tension structure is further connected to a fixed base.

3. A light weight high strength rotor structure of claim 2, wherein
the restraining structure including:
a hub riding on a restraining structure shaft;
a set of posts including restraining locations at ends of the post for restraining the guy wires;
the tension structure includes:
a set of drive guys connecting the posts of the restraining structure and a drive hub, the drive hub driving a generator when the rotor structure rotates.
